(19) United States
(12) Patent Application Publication
(10) Pub. No.: US 2024/0095860 A1
(43) Pub. Date: Mar. 21, 2024

(54) SYSTEM AND METHOD FOR ENROLLMENT IN GOVERNMENT PROGRAMS FOR SUBSIDIZED GOODS OR SERVICES

(71) Applicant: MAXSIP TEL LLC, Woodmere, NY (US)

(72) Inventor: Israel Max, Woodmere, NY (US)

(73) Assignee: MAXSIP TEL LLC, Woodmere, NY (US)

(21) Appl. No.: 18/235,525

(22) Filed: Aug. 18, 2023

Related U.S. Application Data
(60) Provisional application No. 63/407,840, filed on Sep. 19, 2022.

(51) Int. Cl. G06Q 50/26; G06Q 20/04; G06Q 30/018

(52) U.S. Cl. CPC G06Q 50/26; G06Q 20/047; G06Q 30/018

(57) ABSTRACT

Device, system and method for enrolling a user to a government program for free and/or subsidized benefits. The device comprises a user interface for displaying output and receiving input from the user, and a transceiver configured to receive, via a communications network, data from a verification system and transmit data to the verification system. The device also comprise a processor and a set of instructions executable by the processor. The set of instructions operable to: obtain an input corresponding to a status of an application for the program; obtain an identifier and retrieve an existing application corresponding to the identifier, or initiate new application when the application was not previously initiated; transmit the authorization request to a verification system to determine eligibility of the user based on the input data; and obtain from the verification system authorization data indicating whether the user is approved or denied.

### PRIORITY CLAIM

This application claims priority to U.S. Provisional Application Ser. No. 63/407,840 filed Sep. 19, 2022 the entire contents of which is hereby incorporated by reference herein.

### FIELD OF INVENTION

The present invention relates to systems and methods for enrollment of a user in a program having approval criterion, such as, for example, a government program with qualification requirement, and for providing goods and/or services of under the government program to the user.

### BACKGROUND OF INVENTION

There are a number of different government programs that provide subsidies to households and/or individuals having income below certain thresholds, or otherwise meet criterion for participating in the government programs. For example, the Affordable Connectivity Program (ACP) is an FCC benefit program that help families and households struggling to afford internet service. The benefit provides a discount of up to $30 per month toward internet service for eligible households and up to $75 per month for households on qualifying Tribal lands. The program also provides one device discount on a laptop, tablet, or desktop computer. Eligible households can receive a one-time discount of up to $100 to purchase a laptop, desktop computer, or tablet from participating providers if they contribute more than $10 and less than $50 toward the purchase price. As another example, Lifeline program is a federal program that lowers the monthly cost of phone or internet service. The Lifeline program provides up to a $9.25 monthly discount on phone or internet service and $34.25 monthly discount for households on qualifying tribal lands.

These programs help connect eligible households to jobs, critical healthcare services, virtual classrooms, and more online. The benefits provided by these programs can often improve the quality of life for eligible households. In particular, benefits that provide eligible households with subsidized or free access to telecommunications services can often improve the quality of life for participants by lowering the burden for accessing websites, apps and social media platforms and staying connected to friends and family. However, eligible households are often not aware of these programs, their eligibility in these programs, or find it burdensome to apply for and receive the benefits provided by the government programs.

Enrollment in these government programs have typically been manually conducted by representatives soliciting potential participants to apply for these programs. These representatives often are on the street or in neighborhood gathering areas. This manual enrollment process requires potential participants to interact face-to-face with the representatives, who are typically strangers to potential participants, to collect personal information from the potential participants for assessing eligibility for participation in these programs. The information collected can include sensitive and personal information. Potential participants may be wary of providing such personal information to a stranger approaching them in public, and therefore, may be reluctant to interact with the representatives to enroll in the government programs. Furthermore, the availability of these representatives are often limited and therefore, these representative are often not available when potential participants are available or at a time most needed by potential participants.

Therefore, there is a need for systems and methods that provide improved ways to enroll eligible participants in government programs in a manner that is accessible and easy to use.

### BRIEF SUMMARY OF THE INVENTION

The invention comprises a device, such as a kiosk or a vending machine for enrollment in the ACP, Lifeline or a similar program and for dispensing preprogrammed tablets, phones, SIM cards or other devices.

One example of the present application is directed to a system for enrolling a user to a program for a government subsidized telecommunications device and service. The system comprises a database for storing application data related to a plurality applicants with their corresponding unique identifiers. Each unique identifier corresponds to each one of the plurality of applicants. The system also comprises a server configured to be connected to the database and a government verification system for determining whether the user is eligible for enrollment into the program. The system further comprises one or more of a device. The device comprise a user interface for displaying output and receiving input from the user, and a transceiver configured to receive, via a communications network, data from the government verification system and transmit data to the government verification system. The device further comprise a processor and a non-transitory computer readable storage medium including a set of instructions executable by the processor. The set of instructions operable to obtain, via a user interface, an input corresponding to a status of an application for the program; obtain, via the user interface, an identifier and retrieving, via a communications network, an existing application corresponding to the identifier from the database, via the server, when the status indicates the application was previously initiated, and initiate a new application for the program when the status indicates the application for the program was not previously initiated; obtain, via the user interface, input data from the user for completing the application for the program when a new application is initiated or when the previously initiated application for the program was not previously completed; and transmit, via a communications network, the input data to the server. The server comprises a processor and a non-transitory computer readable storage medium including a set of instructions executable by the processor, the set of instructions operable to: generate an authorization request based on the input data, the existing application or a combination thereof, transmit, via a communications network, the authorization request to the government verification system to determine eligibility of the user for the program based on the input data, and obtain from the government verification system, via the communications network, authorization data indicating whether the user is approved or denied. If the user is approved the authorization data further comprises an amount of subsidy approved for the user.

These and other aspects of the invention will become apparent to those skilled in the art after a reading of the following detailed description of the invention, including the figures and appended claims.

### BRIEF DESCRIPTION OF THE DRAWINGS

FIG. 1 shows an exemplary device for enrolling a user to a program for subsidized goods or services, according to an exemplary embodiment of the present application.

FIG. 2 shows an exemplary kiosk for enrolling a user to a program for subsidized goods or services, according to an exemplary embodiment of the present application.

FIG. 3 shows an exemplary vending machine for enrolling a user to a program for subsidized goods or services, according to an exemplary embodiment of the present application.

FIG. 4 shows an exemplary system for enrolling a user to a program for subsidized goods or services, according to an exemplary embodiment of the present application.

FIG. 5 shows an exemplary method for enrolling a user to a program for subsidized goods or services, according to an exemplary embodiment of the present application.

FIG. 6 shows an exemplary method for transacting with a user to provide subsidized goods or services via a kiosk, according to an exemplary embodiment of the present application.

FIG. 7 shows an exemplary method for transacting with a user to provide subsidized goods or services via a vending machine, according to an exemplary embodiment of the present application.

FIG. 8 shows a flow chart of routines, according to the exemplary embodiment Example 1 of the present application.

### DETAILED DESCRIPTION OF THE INVENTION

Throughout this specification and the claims which follow, unless the context requires otherwise, the word “comprise,” and variations such as “comprises” and “comprising,” will be understood to imply the inclusion of a stated integer or step or group of integers or steps but not the exclusion of any other integer or step or group of integers or steps. When used herein the term “comprising” can be substituted with the term “containing” or “including” or sometimes when used herein with the term “having.”

As used herein, the conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options Is also understood to fall within the meaning, and therefore satisfy the requirement of the term “and/or.”

The present application relates to devices, systems and methods for enrollment of a user in a program having approval criterion, such as, for example, a program for providing goods and/or services of the program to a qualified user. In particular, the program may be a subsidy program (e.g., a government subsidy program) for providing free and/or discounted goods and/or services to a qualified user. The amount of subsidy may be for the entirety of the cost of the goods and/or services (i.e., the goods and/or services could be fully subsidized and therefore, free to the user) or the amount of subsidy may be for a portion of the cost of the goods and/or services (i.e., the goods and/or services being partially subsidized and therefore, the user would need to provide a co-pay that is lower than the cost of the goods and/or services). For example, the program may be a government subsidy program for providing free and/or discounted telecommunications devices and/or services to a qualified user, such as, for example, ACP, Lifeline or similar telecommunications subsidy programs that provide free or discounted telecommunications devices and/or services to the user. More specifically, the devices, systems and methods of the present application enroll eligible users in subsidy programs (e.g., government subsidy or private subsidy, such as discounts from vendor) for providing free or discounted Internet and/or phone service. The device, system and methods of the present application may enroll eligible users in subsidy programs (e.g., government subsidy or private subsidy, such as discounts from vendor) for providing free or discounted Internet (e.g., ISP or WiFi) and/or phone service and provide users with associated tablets, SIM cards, and/or phones. In particular, the devices, systems and methods of the present application may enroll eligible users in government subsidy programs for providing free or discounted Internet, phone service and/or associated tablets, computers or laptops. If a user is enrolled in a government subsidy program, then a private subsidy or discount may also be provided for associated phones and/or SIM cards. The private subsidy or discount also be provided for any other device associated with a subsidized telecommunications service (e.g., internet connection), for example, a smart watch.

The present application provides the advantage of allowing a user to enroll in a program without interfacing with a human representative soliciting for participation in the program, who is often a stranger to the user. The user can utilize a device of the present application to input personal information for enrollment in a subsidy program without interfacing with another person as an intermediary, and therefore, provide improved privacy and reduced social stigma for applying for and/or participating in such a program. Additionally, the present application provides devices, systems and methods for enrolling a user that improves ease of access to potential users of the program by providing devices that allow for more user-friendly availability and placement at user friendly locations, as compared to the human representative soliciting for participation. In some examples, the devices, systems and methods of the present application do not require a human attendant to be available for the user to enroll in the program. Therefore, these device, system and methods may have greater availability as compared to enrollment manually conducted by human representatives soliciting potential participants to apply for these programs. In a particular example, the devices, system and methods of the present application is available at all times. The increase in availability allows for users to interact with and enroll in the program at a time most convenient or most needed by the user. Furthermore, the devices of the present application may be easily independently installed and movable to locations that are accessible to potential participants. In one example, the device may be placed in malls, churches government program offices, train/subway stations, bus stops, thrift shops, Red Cross locations, convenience stores (e.g., 7/11 or bodegas), laundromats, etc. In another example, the devices may be placed in locations to target potential users that may need the assistance of the program the most, such as for example, near homeless shelters.

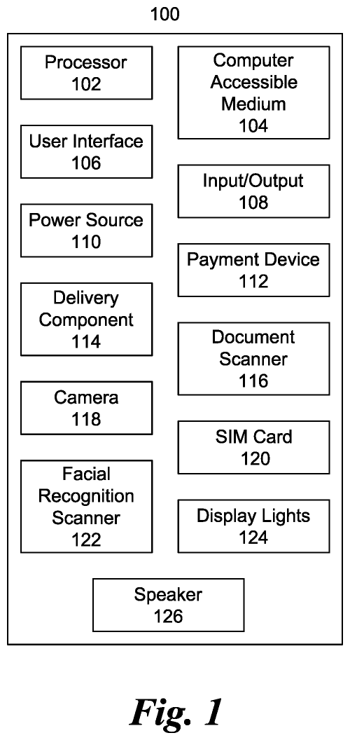

FIG. 1 shows an exemplary embodiment of a device 100 for enrolling a user to a program for subsidized (as described herein, the term subsidized may refer to fully subsidized, i.e., free to the user, or partially subsidized, i.e., the user provides a co-pay in amount lower than the full price) goods or services, in particular, telecommunications devices and/or services. In particular, the device 100 is a vending machine or a kiosk. The kiosk may be any type of kiosk, such as, for example, a standalone kiosk, a handheld kiosk or a tabletop kiosk. The device 100 comprises a processor 102 and a computer accessible medium 104. The processor 102 can include, e.g., one or more microprocessors, and use instructions stored on the computer-accessible medium 104 (e.g., memory storage device). The computer-accessible medium 104 may, for example, be a non-transitory computer-accessible medium containing executable instructions therein. The device 100 further comprises a user interface 106 (e.g., a touchscreen) for obtaining input from a user and displaying output to the user. It is contemplated that the user interface 106 may also be two or more separate components for displaying an output to the user and obtaining inputs from the user, such as, for example, a display and a keyboard. In one embodiment, the user interface 106 may comprise a component for displaying an output to the user (e.g., a display), a component for obtaining inputs from the user (e.g., a keyboard or touchscreen), and/or a code scanner (e.g., 2-D barcode or QR code scanner) for providing input data to the device 100. The code scanner may comprise any suitable components for obtaining data encoded in a barcode or QR code, for example, the code scanner may be a digital camera or any other optical device for capturing an image of the 2-D barcode or QR code and generating data from the images to obtain data encoded in the barcode or QR code. The user interface 106 is operably connected to the processor 102 to receive instructions, as discussed further below, for generating an output on the user interface and provide data corresponding to inputs obtained from the user to the processor 102. In one example, the user interface 106 may comprise a privacy display such that output shown on the user interface 106 is directed to the user and difficult to view from other angles so as to protect the user's privacy.

The device 100 includes an input/output device 108 for receiving and/or transmitting data or instructions to or from the device 100. The input/output device 108 may be operably connected to via a communications network (e.g., Internet, Wi-Fi, ethernet, cellular network, etc.) to transmit data to and to receive data, instructions, and/or authorizations from the communications network. In one example, the input/output device 108 may be a USB Wi-Fi device. In particular, the input/output device 108 may be a transceiver for receiving data or instructions to and/or transmitting data from the device 100. In another example, the input/output device 108 comprises a SIM card for wirelessly connecting the device 100 to the same communications network as the input/output device 108 or a different communications network (e.g., Internet, Wi-Fi, ethernet, cellular network etc). For example, the input/output device 108 may be operably connected via Wi-Fi or ethernet to the Internet and the SIM card may be operably connected via a cellular network to the Internet. In a further example, the device 100 may optionally include a SIM card 120 for wirelessly connecting the device 100 to the communications network 404 in addition to the input/output device 108 to provide more than one way to connect the device 100 to the communications network 404.

The device 100 also includes a power source 110 for providing power to control and operate the device 100. The power source 110 may be located anywhere within the device 100 (e.g., a battery stored within the device), or a power connector interfacing with a power source external (e.g., wall plug) to the device 100. The device 100 also includes a payment device 112 for receiving payment from the user. The payment device 112 may be any suitable device for receiving payment from the user. For example, the payment device 112 may be a credit card reader, a cash (e.g., bills or coins) acceptor, a code scanner for receiving payment codes via a payment service (e.g., Cashapp, Paypal, Venmo, etc.) or a combination thereof. The code scanner may be a 2-D barcode scanner or a QR code scanner. In some examples, the payment device 112 may utilize the same code scanner that is part of the user interface 106. In particular, the code scanner may be utilized as part of the user interface 106 to obtain data corresponding to information from the user and also function as a payment device 112 for receiving payment codes. In other examples, the payment device 112 is a code scanner that is separate from the user interface 106.

The device 100 further includes a delivery component 114. In one embodiment, the delivery component 114 for providing a telecommunication device (e.g., a laptop computer, a mobile tablet, a smart phone, a SIM card, cable set-top box, etc.) which may optionally be activated with an associated telecommunications service (e.g., Internet, intranet, phone, cable, or other telecommunications services) to the user or for providing a receipt with a unique identifier (e.g., an order number) corresponding to an order of the user for a telecommunications device and/or telecommunications service. In a particular embodiment, the delivery component 114 provides a telecommunications device that is activated with a government subsidized telecommunications service to the user or for providing a receipt with a unique identifier corresponding to an order of the user for a telecommunications device and associated service. For example, the program may be a government subsidy program for providing free and/or discounted telecommunications devices and/or services to a qualified user and the delivery component 114 dispenses the telecommunications devices, such as, a laptop computer, a mobile tablet, a smart phone, a SIM card, cable set-top box or any other suitable computing device for connecting to a telecommunications network (e.g., Internet, intranet, phone, cable, etc.) or the delivery component 114 provides a receipt with a unique identifier (e.g., order number) corresponding to an order of the user for a telecommunications device and/or telecommunications service. The term “order” as used herein refers to an application by the user for a telecommunications device and/or telecommunications service initiated using the system 400 of the present application, described further below. An order does not encompass applications for a telecommunications device and/or telecommunications service initiated directly or indirectly with a National Verifier (NV) and/or equivalent state-specific portal (e.g., California Oregon or Texas specific portal) without utilizing at least a portion of the system 400 of the present application.

In another embodiment, the delivery component 114 comprises a printer for delivering a printed output to the user. The printer may provide any suitable codes (e.g., bar codes or QR codes) associated with the user or instructions to the user. For example, the instructions may comprise instructions for uploading data corresponding to images of documents via a secured link. In one example, the printer may provide a receipt or other printed form of acknowledgement for receiving an order or a portion of the order for the program for subsidized goods or services. In another example, the printer may provide a receipt with a unique identifier, such as an alphanumeric code, a bar code or a QR code corresponding to each user's order and/or enrollment in the program for subsidized (e.g., free or discounted) goods or services. The receipt generated by the printer may further include a summary of information of the telecommunications device(s) and/or service(s) provided, enrollment into one or more government programs for subsidized goods and/or services, unique identifier (e.g., order number) associated with an order, or a combination thereof. In a particular example, the program may be a government subsidy program for providing free and/or discounted telecommunications devices and/or services to a qualified user and the printer may provide a receipt with a unique identifier (e.g., order number) corresponding to an order of the user for a telecommunications device and/or telecommunications service subsidized by the program.

The device 100 may optionally include a document scanner 116 for scanning and capturing images of physical documents provided by the user and generating data corresponding to images captured by the document scanner 116. The data generated by the document scanner 116 may be further analyzed or utilized by the processor 102 for enrolling the user to the program.

The device 100 may also optionally include a camera 118 for capturing images of the user and/or surrounding environment and generating data corresponding to the captured images. The data generated by the camera 118 may be stored in connection with an order by the user or may be further analyzed by the processor 102 to make one or more determinations, such as, for example, verification of the user's identity, whether or not there is fraudulent activity, etc. The camera 118 may record a portion of or the entire time the user interacts with the device 100. The camera 118 may also record the surroundings of the device when it is not in use. For example, the camera 118 may record any engagement of the user with the device. In another example, the camera 118 may record any engagement of an agent or an owner of a store in which the device 100 is placed. The recordings obtained by the camera 118 may be used to prevent fraud in all parts of an enrollment process.

Furthermore, the device 100 may optionally include a facial recognition scanner 122 for scanning the user's face and generating data corresponding to features of the user's face. The data generated by the facial recognition scanner 122 may be analyzed by the processor 102 to verify the user's identity. The facial recognition scanner 122 may be a separate device (as shown in FIG. 1). Alternatively, the camera 118 may also function as the facial recognition scanner 122, and therefore a separate component for the facial recognition scanner 122 is not included. The data obtained by the facial recognition scanner 122 may be analyzed by the processor 102 to verify the user's identity. For example, the processor 102 may obtain historic data (i.e., previously obtained data corresponding to images and/or facial features of the user) from a database external to the device 100 and compare the data generated by the facial recognition 122 to the historic data retrieved from the external database, such as, for example, database 406, as described further below.

In some examples, the device 100 may optionally include further components that provide lights, sounds and/or promotional materials to attract potential users. For example, device 100 may optionally include a speaker 126 for generating sounds to attract potential users. The device 100 may also optionally include display lights 124 separate from the user interface 106 for providing lights and/or promotional materials to attract potential users. The speaker 126 and/or display lights 124, and/or user interface 106 are operably connected to the processor 102 to receive instructions for generating sounds, music, colorful lighting and/or promotional material (e.g., promotional displays and sounds).

The device 100 may comprise of multiple parts connected together to form a single operating device. Preferably, the device 100 is a unitary device, where all of the components of the device 100 are within a single unit, for example, all of the components of the device 100 are part of a single device. In some examples, all of the components of the device 100 are on or enclosed within a housing (not shown) of the device 100.

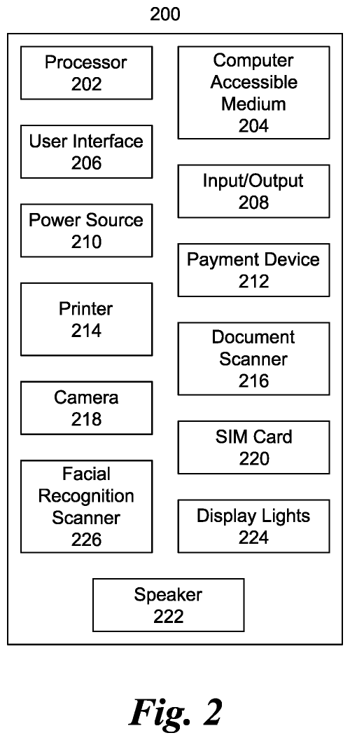

FIG. 2 shows an embodiment of a kiosk 200 for enrolling a user to a program for subsidized goods or services, in particular, telecommunications devices and/or services. The kiosk 200 is configured to accept information and data from the user, transmit data generated based on data provided by the user to a communications network, and receive data, instructions, and/or authorizations from the communications network, but does not dispense the goods or services from the kiosk 200. The kiosk 200 comprises a processor 202, a computer-accessible medium 204, a user interface 206, an input/output device 208 (and optionally a SIM card 220), a power source 210 and a payment device 212, each of which is substantially the same as the corresponding components described above with respect to device 100 above. The kiosk 200 may optionally comprise a document scanner 216, a camera 218, a facial recognition scanner 226, or a combination thereof. Each of the document scanner 216, the camera 218, the facial recognition scanner 226 is also substantially similar to the document scanner 116, the camera 118, and the facial recognition scanner 122 describe above with respect to device 100.

Additionally, the kiosk 200 may further comprise a printer 214 for providing a printed output to the user. The printer 214 may provide any suitable codes (e.g., bar codes or QR codes) associated with the user or instructions to the user. For example, the instructions may comprise instructions for uploading data corresponding to images of documents via a secured link. In one example, the printer 214 may provide a receipt or other printed form of acknowledgement for receiving an order or a portion of the order for the program for subsidized goods or services. In another example, the printer 214 may provide a receipt with a unique identifier, such as an alphanumeric code, a bar code or a QR code corresponding to each user's order and/or enrollment in the program for subsidized goods or services. The receipt generated by the printer 214 may further include a summary of information of the telecommunications device(s) and/or service(s) provided, enrollment into one or more government programs for subsidized goods and/or services, unique identifier (e.g., order number) associated with an order, or a combination thereof. In a particular example, the program may be a government subsidy program for providing free and/or discounted telecommunications devices and/or services to a qualified user and the printer 214 may provide a receipt with a unique identifier (e.g., order number) corresponding to an order of the user for a telecommunications device and/or telecommunications service subsidized by the program. The printer 214 may also be used to print marketing and promotional materials.

In some examples, the kiosk 200 may optionally include further components that provide lights, sounds and/or promotional materials to attract potential users. For example, kiosk 200 may optionally include a speaker 222 and/or display lights 224 similar to speaker 126 and display lights 124 described above for device 100.

The kiosk 200 may comprise of multiple parts connected together to form a single operating device. Preferably, the kiosk 200 is a unitary device, where all of the components of the kiosk 200 are within a single unit, for example, all of the components of the kiosk 200 are part of a single device. In some examples, all of the components of the kiosk 200 are on or enclosed within a housing (not shown) of the kiosk 200.

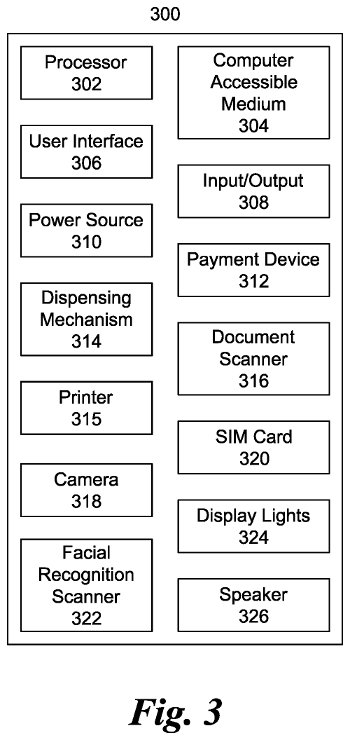

FIG. 3 shows an embodiment of a vending machine 300 for enrolling a user to a program for subsidized goods or services, in particular, telecommunications devices and/or services. The vending machine 300 is configured to accept information and data from the user, transmit data based on data provided by the user to a communications network, and receive data, instructions, and/or authorizations from the communications network, and also to dispense the goods or services from the vending machine 300. The vending machine 300 comprises a processor 302, a computer-accessible medium 304, a user interface 306, an input/output device 308 (and optionally a SIM card 320), a power source 310 and a payment device 312 that is substantially the same as the corresponding components described with respect to device 100 above. The vending machine 300 may optionally comprise a document scanner 316, a camera 318, a facial recognition scanner 322, or a combination thereof. Each of the document scanner 316, the camera 318, the facial recognition scanner 322 is also substantially similar to the document scanner 116, the camera 118, and the facial recognition scanner 122 describe above with respect to device 100.

The vending machine 300 further comprises a dispensing mechanism 314 for dispensing a subsidized good and/or service, such as, for example, telecommunications device and service, to a qualified user. In particular, the dispensing mechanism 314 dispenses a telecommunication device (e.g., a laptop computer, a mobile tablet, a smart phone, a SIM card, cable set-top box, etc.) which may optionally be activated with an associated telecommunications service (e.g., Internet, intranet, phone, cable, or other telecommunications services) to the user. In a particular embodiment, the dispending mechanism 314 dispenses a telecommunications device that is activated with a government subsidized telecommunications service to the user. The dispensing mechanism 314 may be any suitable vending mechanisms for storing a plurality of different products (e.g., telecommunications devices) and dispensing a selected product to the user. For example, the dispensing mechanism 314 comprises a plurality of gravity-fed slots, where each slot holds a type of product. The slots may contains a barrier that prevents dispensing of the product. The dispensing mechanism 314 may be activated to temporarily disengage the barrier for the slot corresponding to the selected product to dispense the selected product to the user. In another example, each slot of the dispensing mechanism 314 comprises a coil holding a product between each loop of the coil. The dispensing mechanism, 314 may be activated to advance the coil for the slot corresponding to the selected product to dispense the selected product to the user. The vending machine 300 may optionally include a printer 315 to providing a printed output to the user. The printer 315 is substantially similar to the printer 214 describe above with respect to kiosk 200.

In some examples, the vending machine 300 may optionally include further components that provide lights, sounds and/or promotional materials to attract potential users. For example, vending machine 300 may optionally include a speaker 326 and/or display lights 324 similar to speaker 126 and display lights 124 described above for device 100.

The vending machine 300 may comprise of multiple parts connected together to form a single operating device. Preferably, the vending machine 300 is a unitary device, where all of the components of the vending machine 300 are within a single unit, for example, all of the components of the vending machine 300 are part of a single device. In some examples, all of the components of the vending machine 300 are on or enclosed within a housing (not shown) of the vending machine 300.

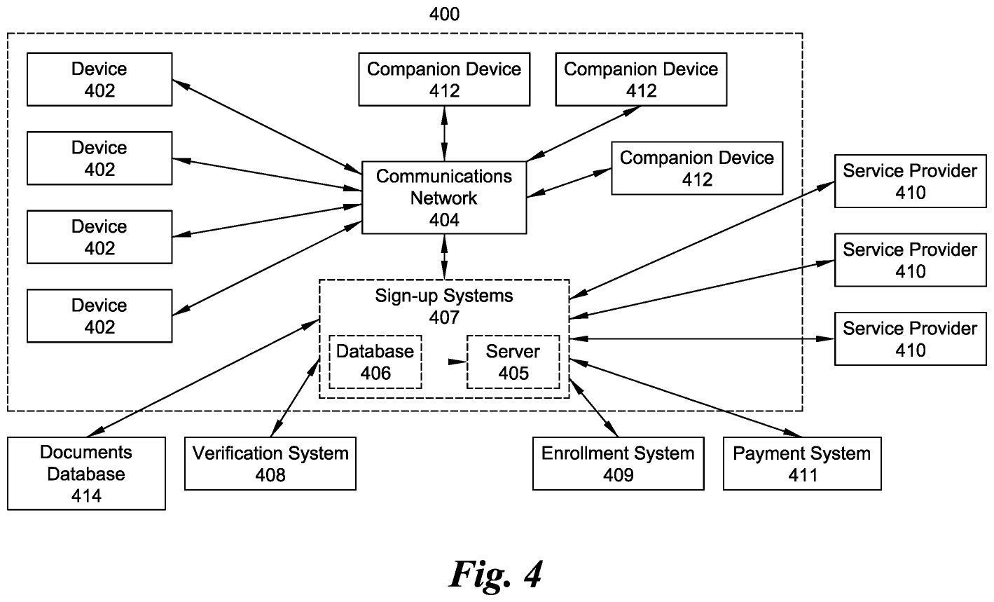

FIG. 4 shows an embodiment of a system 400 for enrolling a user to a program for subsidized goods or services, in particular, telecommunications devices and/or services. The system 400 comprises a plurality of devices 402 located at various different locations, a sign-up system 407, and one or more companion device(s) 412 that may be located at different locations. The devices 402 is operably connected to the sign-up system 407 via a communications network 404 (e.g., Internet, Wi-Fi, ethernet, cellular network, etc.). Similarly, the one or more companion device(s) 412 are operably connected to the sign-up system 407 via the communications network.

The devices 402 may be located at any suitable public location and enable users to apply for the program, without the assistance of a representatives (e.g., street agent) for the program. The devices 402 may be placed in locations where potentially eligible user are likely found, such as, for example, malls, churches government program offices, train/subway stations, bus stops, thrift shops, Red Cross locations, convenience stores (e.g., 7/11 stores or bodegas), laundromats, homeless shelters, etc. In some examples, the devices 402 are compact and/or within a single unit (e.g., all of the components of the device 402 are on or enclosed within a housing of the device 402) and easily deployable at these locations (e.g., plug into a power source to begin use of the device 402). Each device 402 may be independently selected from device 100, kiosk 200, or vending machine 300. Therefore, the system 400 may include a mix of different devices (e.g., a mix of devices 100, kiosks 200 and vending machines 300).

The sign-up system 407 is operably connected, either via the communications network 404 or via a direct connection to a verification system 408, and optionally, to an enrollment system 409, a payment system 411 and/or one or more service provider(s) 410, which are discussed further below. In some embodiments, the sign-up system 407 (e.g., such as one for assisting users in enrolling in ACP or Life Line) is operably connected, either via the communications network 404 or via a direct connection to a verification system 408, and to an enrollment system 409, a payment system 411 and/or one or more service provider(s) 410. The sign-up system 407 comprises a server 405 and a database 406. The database 406 may serve as a repository for each order for (1) information and/or data received from a device 402 or companion device 412; (2) data, instructions and/or authorization received from the verification system 408; (3) enrollment data and/or information, such as for example, enrollment data received from the enrollment system 409; (4) activation data from service provider 410; (5) for storing data corresponding to documents obtained from the documents database 414; and/or (6) information related to payment data from payment system 411. Additionally, the sign-up system 407 may be optionally connected, either via the communications network 404 or via a direct connection to a documents database 414.

In particular, the database 406 is configured to store information and/or data corresponding to each order. For example, each order may be associated with a corresponding unique identifier, such as, for example, an order number (referred herein as “Order ID”), other unique codes (e.g., alphanumeric code, bar code, QR code) associated with the order, or other suitable data that uniquely identifies the user, such as, for example, the user's name, the user's social security number, the user's phone number, or other personal information. Information and/or data corresponding to each order may be stored within the database 406 with a corresponding unique identifier. The database 406 is configured such that the server 405 can retrieve from the database 406 information and/or data corresponding to an order based on the order's unique identifier. The database 406 is also configured such that the server 405 can provide information and/or data corresponding to an order along with a unique identifier for the order for storing in the database 406.

The server 405 is configured to received data from one or more of the device(s) 402 and transmit instructions or data to the device(s) 402. The server 405 may be connected to the database 406 via a direct wired connection or may be wirelessly connected. In some examples, the server 405 and the database 406 may be in separate locations and connected via a private network or via the communication network 404. For example, the device(s) 402 may transmit information and/or data corresponding to an order to the sign-up system 407. The sign-up system 407 receives the information and/or data corresponding to an order and generates a unique identifier for the order. The server 405 is operably connected to the database 406 to transmit the information and/or data corresponding to the order received from the device(s) 402 along with the corresponding unique identifier to the database 406 for storing such information and/or data with the corresponding unique identifier in the database 406. In another example, a device 402 may transmit a unique identifier for an order to the server 405. The server 405 is also operably connected to the database 406 to retrieve from the database 406 information and/or data corresponding to an order based on the unique identifier received from the device 402. The server 405 is further configured to transmit the corresponding information and/or data retrieved from the database 406 based on the unique identifier to the device 402 that provided the unique identifier.

The server 405 may optionally be operably connected, either via the communications network 404 or via a direct connection, to a documents database 414. The documents database 414 may be any suitable database for providing data corresponding to a document for applying to the program. For example, the server 405 may receive from the device(s) 402 reference information and/or data for referencing the documents database 414. The server 405 may transmit the reference information and/or data received from the device(s) 402 to the documents database 414 to retrieve a corresponding document for a particular user. For example, the documents database 414 may be a government documents database for other types of subsidies or benefits, such as a database for Medicaid, e.g., ePACES database. The data corresponding to a document retrieved from the documents database 414 may be saved in database 406 corresponding with a unique order ID, as discussed further below. Then, the data corresponding to the document may be used (in whole or in part) in a request for the verification system 408 to approve the user for enrolling in a program for subsidized goods or services, in particular, telecommunications devices and/or services using the system, which is also discussed further below.

The server 405 is also operably connected, either via the communications network 404 or via a direct connection, to the verification system 408 for transmitting information and/or data received from a device 402 to the verification system 408 and receiving data, instructions and/or authorization from the verification system 408. The server 405 may communicate with the verification system 408 through any suitable means, for example, the server 405 may communicate with the verification system 408 via an application programming interface (API).

In one example, the server 405 may retrieve data stored within the database 406 associated with a particular user (e.g., with a unique identifier, such as, a particular Order ID) and transmit information and/or data for the particular user to the verification system 408 and receive data, instructions and/or authorization from the verification system 408. The server 405 may transmit to and store the data, instructions and/or authorization from the verification system 408 in the database 406, and associate the data, instructions and/or authorization from the verification system 408 with the corresponding unique identifier (e.g., Order ID) for the user. The server 405 may subsequently send a response obtained from the verification system 408 to device 402 for output on a user interface for the user to see the response.

The verification system 408 may be any server or system comprising a group of servers and/or databases for determining eligibility of a user in a subsidy program, for example, a government program for free or subsidized telecommunications devices and/or services. For example, the verification system 408 may comprise a National Verifier (NV) and/or equivalent state-specific portal (e.g., California Oregon or Texas specific portal) for determining eligibility of an applicant in a government subsidy program. More particularly, the verification system 408 comprises a NV or equivalent state specific portal for determining eligibility of an applicant in a government telecommunications subsidy program, such as, for example, ACP or Lifeline.

Additionally, the server 405 may optionally be operably connected, either via the communications network 404 or via a direct connection, to an enrollment system 409. The enrollment system 409 registers enrollment of a user in a program for subsidized goods and/or services, in particular, telecommunications devices and/or services. In some examples, the server 405 is operably connected, either via the communications network 404 or via a direct connection, to the enrollment system 409. The server 405 is operably connected either via the communications network 404 or via a direct connection, to the enrollment system 409 for transmitting information and/or data received from a device 402 and/or data stored in database 406 for an order to the enrollment system 409 for enrolling the user in the program for subsidized goods and/or services upon receiving an approval authorization from the verification system 408. For example, the enrollment system may comprise a National Lifeline Accountability Database (NLAD) or a state equivalent portal, such as those for CA, OR or TX. The initiation of data sent from the server 405 to the enrollment system 409 occurs upon receiving an input initiating such a transfer from device 402 or companion device 412. The initiation of data sent from the server 405 to the enrollment system 409 may also occur without further input from the user upon receiving authorization data indicating that the user is approved from the verification system 408.

The server 405 may also receive data from the enrollment system 409 regarding enrollment status and details of the user, and transmit the data received from the enrollment system 409 to the database 406 for storing with the unique identifier corresponding to the order of the information and/or data received from the device 402. The authorization received from the enrollment system 409 may be saved in database 406 corresponding with a unique order ID. The server 405 may subsequently send the authorization obtained from the enrollment system 409 to device 402 for output on a user interface to display the authorization to the user. In summary, the enrollment data which results from an enrollment attempt with the enrollment system 409 may be stored in the database 406 and displayed by the device 402 or by the companion device 412.

In some examples, the server 405 may engage with database 406 to keep track of what device has been given to the user, for example, assigning a particular device to a user. The initiation of the process may occur from device 402 or companion device 412 and the associated information may be stored in database 406. Furthermore, the server 405 may optionally be operably connected, either via the communications network 404 or via a direct connection, to one or more telecommunications service provider(s) 410 (e.g., cellular service provider, such as, T-Mobile, Internet service provider, cable service provider etc.). In some examples, such as when the user is enrolling with ACP or Lifeline, the server 405 is operably connected, either via the communications network 404 or via a direct connection, to one or more telecommunications service provider(s) 410 (e.g., cellular service provider, such as, T-Mobile, Internet service provider, cable service provider etc.). The telecommunications service provider(s) 410 activates and provides telecommunications services based on the authorization data stored in the database 406, which includes authorizations previously provided by the verification system 408 and/or enrollment system 409 for an order. As discussed herein, when a determination is based on the authorization data, it is meant that the authorization data may directly determine whether or not the user is provided with a telecommunications service and/or device, or may be used as a basis for determining whether additional subsidies may be provided to the user (e.g., additional subsidies as determined by the sign-up system 407, such as, for example, criteria for pre-determined business policies applied by the sign-up system 407). For example, the telecommunications service provider(s) 410 provisions free or subsidized services (e.g., cellular or Internet services) under the program, based on the authorization data stored in the database 406, which includes authorizations previously provided by the verification system 408. The server 405 may be operably connected to one or more service provider(s) 410 either via the communications network 404 or via a direct connection, for transmitting data and/or instructions to the service provider(s) 410, based on the authorization data stored in the database 406, which includes authorizations previously received from the verification system 408 and/or the enrollment system 409. In some examples, the telecommunications service provider(s) 410 may provide to the server 405 data corresponding to information (e.g., MDN generated by the service provider 410 for the user, serial number, etc.) regarding a telecommunications device and/or service provisioned to the user. The server 405 is configured to receive such data regarding the telecommunications device and/or service provisioned and transmit such data to the database 406 for storing in the database 406 along with a unique identifier (e.g., Order ID) for the order. Optionally, the server 405 may transmit such data regarding the telecommunications device and/or service provisioned to the device 402 or companion device 412 and display such data on the device 402 or companion device 412.

Optionally, the system 400 further comprise a plurality of companion devices 412 that can be located anywhere for completing delivery of subsidized telecommunications devices and/or services. The companion devices 412 may comprise a processor, a code scanner (e.g., barcode or QR code scanner), and a transceiver for transmitting data via the communications network 404 and receiving data from the communications network 404. For example, the companion device 412 may be a mobile phone or tablet device.

The companion device 412 may be operably connected to the sign-up system 407 to transmit data obtained by the code scanner to the server 405. The data obtained by the code scanner correspond to a unique identifier for an order (e.g., Order ID). In some examples, the companion device 412 and/or device 402 may transmit data to the server 405 initiating steps for transmitting information and/or data for a user to obtain authorization data from the verification system 408 and/or enrollment system 409, as discussed further below.

In one example, the server 405 may retrieve data stored within the database 406 associated with a particular user (e.g., with a unique identifier, such as, a particular Order ID) and transmit information and/or data for the particular user received from the database 406 and/or received from the device 402 to the enrollment system 409 for enrolling the user in the program for subsidized goods and/or services and/or to a telecommunications service provider 410 to activate and provide telecommunications services based on the authorization data provided by the verification system 408 and/or enrollment system 409, as discussed above. In some examples, the authorization data may authorize telecommunications services but not a telecommunications device. The server 405 may analyze the authorization data and determine whether to provide a telecommunications device at full price, at a discount, or for free. In another example, the server 405 may transmit information and/or data for the user received from the database 406 and/or received from the device 402 to the enrollment system 409 to retrieve information regarding eligibility for a subsidized (e.g., discounted) telecommunications device and the server 405 may determine based on the information obtained from the enrollment system 409 whether to provide the telecommunications device at full price, at a discount, or for free. In an additional example, the companion device 412 may initiate a process to engage with server 405 and database 406 to keep track of what device has been given to the user, for example, assigning a particular telecommunications device to a user. The companion device 412 may also be used obtain additional inputs from the user to resolve any rejections that may arise during the verification/enrollment process as described further below in steps 518, 519 and 520 and transmit the additional inputs to the server 405.

In another example, the server 405 may retrieve data stored within the database 406 associated with a particular user (e.g., with a unique identifier, such as, a particular Order ID) and transmit information and/or data for the particular user received from the database 406 and/or received from the device 402 to verification system 408 and/or enrollment system 409 to confirm eligibility. If the verification system 408 and/or enrollment system 409 confirms eligibility, then the server 405 transmits information and/or data for the particular user received from the database 406 to the enrollment system 409 for enrolling the user in the program for subsidized goods and/or services and/or to a telecommunications service provider 410 to activate and provide telecommunications services, based on authorization data provided by the verification system 408 and/or enrollment system 409. If a payment from the user is needed, server 405 may also contact a payment system 411 and direct the user to provide payment via the payment system 411 for purchase of the subsidized goods and/or services. The payment system 411, and the amount of payment to be requested from the user may be determined based on the authorization data, as discussed further below.

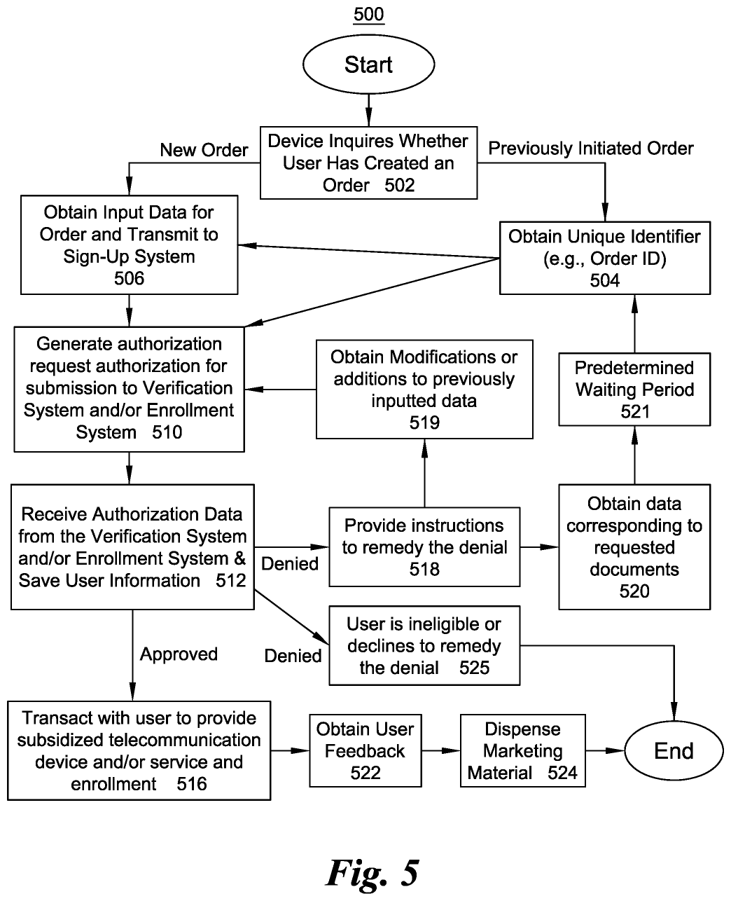

FIG. 5 shows an exemplary method 500 for enrolling a user to a program for subsidized goods or services, in particular, telecommunications devices and/or services using the system 400. More specifically, the program may be a government subsidy program for providing free and/or discounted telecommunication devices and/or services to a qualified user, such as, for example, ACP, Lifeline or similar telecommunications subsidy programs that provide free or discounted telecommunications devices and/or services to the user. The device 402 may be any device 100, kiosk 200 or vending machine 300. The device(s) 402 may set-up for use in locations that are convenient to potentially eligible users, for example, in community locations such as malls, churches government program offices, train/subway stations, bus stops, thrift shops, Red Cross locations, convenience stores (e.g., 7/11 or bodegas), laundromats, etc. The deployment of the device(s) 402, particularly, in community locations improves access to the program for eligible users. The descriptions for method 500 below will be described with respect to system 400 and device 100. However, the method 500 can be similarly applied to a device 402 that is a kiosk 200 or a vending machine 300. The method 500 is capable of enrolling users starting from a new order and provide the full enrollment process at once, or enrolling users that started an order for the program previously within the system 400. The order may be previously initiated by the user by communicating with the server 405. A user can also approach the device 402 to initiate method 500 to enroll in a program for subsidized telecommunications devices and/or services, such as ACP, Lifeline or another similar telecommunications subsidy program.

As an initial step, the device 402 obtains input from the user indicating whether the user has previously initiated an order (step 502). The input may be provided by the user in any suitable manner whether prompted by the device 402 or unprompted by the device. In one example, the user may provide input indicating whether the user has previously initiated an order by responding to an inquiry displayed via a user interface 106. The inquiry outputted to the user interface 106 may include questions or text prompts asking the user whether the user has previously initiated an order or whether the user wishes to start a new order for a device and/or service subsidized by the program. The user interface 106 may, for example, provide, an option for initiating a new order and an option for retrieving a previously initiated order, and the user may select via the user interface 106 one of these two options. If the user selects the option for retrieving a previously initiated order, then the method 500 proceeds to step 504. If the user provides input in step 502 indicating that the user has not previously initiated an order or wishes to start a new order, then the method 500 proceeds to step 506.

In another example, the user may provide input indicating an order was previously initiated by providing a code corresponding to the previously initiated order via the user interface 106 or by scanning with a code scanner of the device 402 a receipt having a previously generated 2-D barcode or QR code corresponding to the previously initiated order. In this example, the method 500 does not require a separate step 504 for obtaining a unique identifier (e.g., Order ID) corresponding to a previously initiated order. Rather, steps 502 and 504 may be performed in a single step together. If the user does not provide input for a code corresponding to the previously initiated order, then the method 500 proceeds to step 506 to initiate a new order.

In step 506, the device 402 obtains input data. In particular, step 506 may obtain input data for a newly initiated order or a previously initiated, but not completed order. Subsequently, the input data is transmitted to the sign-up system 407. In one example, the device 402 may display, via a user interface 106, instructions and/or forms for obtaining input data from the user corresponding to a plurality of data fields for enrollment in the program. The input data corresponds to personal information of the user for completing an application for the program. For example, the user interface 106 may display questions or present open fields to solicit input data for information for completing an application for the program to the user. The user may respond to each of the questions or open fields by manually inputting data corresponding to information in response via the user interface 106. The user interface 106 may display questions or open fields and collect input data from the user relating to any information for assessing eligibility of the user for a program for subsidized or free goods or services, for example, name, birthday, social security number, income, enrollment in other subsidy programs, etc. The inquiries outputted and input obtained from the user preferably corresponds to fields of data for information required for completing an application for a program for subsidized or free goods or services. The user may complete all the necessary fields for enrollment in the program. The user may complete a portion of the necessary fields for enrollment in the program. The input provided by the user may be transmitted by the device 402 to the sign-up system 407 for storing such inputs in the database 406. The program may be a government subsidy program for providing free and/or discounted telecommunication devices and/or services to a qualified user. In particular, the government subsidy program may be, for example, ACP, Lifeline or similar telecommunications subsidy programs that provide free or discounted telecommunications devices and/or services to a qualified user.

In step 510, the sign-up system 407 generates an authorization request for approval for the user to participate in the program. In a first iteration of the method 500, the sign-up system 407, in particular, the server 405 receives input data from the device 402. The input data received by the sign-up system 407 and may be stored in the database 406 along with a unique identifier (e.g., Order ID) for the order. The input data received from the device 402 are used by the server 405 to generate an authorization request for approval for the user to participate in the program. The authorization request comprises personal information of the user generated from input data. The authorization request is transmitted from the sign-up system 407 to the verification system 408 for evaluating whether the user is eligible for participation in the program. In some embodiments, the authorization request is transmitted from the sign-up system 407 to the verification system 408 and the enrollment system 409 for evaluating whether the user is eligible for participation in the program. In another embodiment, two separate authorization requests, which may contain data corresponding to the same or different information, are transmitted from the sign-up system 407 to the verification system 408 and the enrollment system 409 for evaluating whether the user is eligible for participation in the program. It is noted that a unique identifier (e.g., Order ID) for the order may be generated by the sign-up system 407, e.g., the server 405, before or after generating an authorization request for transmitting to the verification system 408 and the input data for the order may be stored in the database 406 associated with the unique identifier (e.g., Order ID) before or after generating an authorization request for transmitting to the verification system 408.

In some embodiments, the user may have previously initiated an application outside of system 400 (therefore, not an order within system 400), for example, directly with the verification system 408 and obtained authorization from the verification system 408. In step 506, the device 402 may obtain input data from the user, which can authorization data previously provided by the verification system 408 to the user, such as, for example, a separate ID for the authorization from the verification system 408 (e.g., National Verifier Application ID), in addition to personal identifying information and/or other types of input data as discussed above. The amount of input data requested from such a user may be less than a user who has not previously been approved by the verification system 408. Subsequently, the input data is transmitted to the sign-up system 407. The sign-up system 407 may store such inputs in the database 406. In this exemplary embodiment, step 510 may skip generating an authorization for approval for the user to participate in the program, and the method 500 may skip step 512 and proceed directly to step 516. In an alternate example, step 510 includes generating an authorization for approval for the user to participate in the program that includes the National Verifier Application ID to confirm that the user has indeed been approved. In this alternative example, the method 500 continues to step 512 to confirm that the user has been approved and the method continues as described below.

In step 512, the authorization request is transmitted by server 405 of the sign-up system 407 to the verification system 408 and/or enrollment system 409 for evaluating the user's eligibility to participate in the program. The server 405 subsequently receives authorization data from the verification system 408 and/or enrollment system 409 indicating whether the verification system 408 and/or the enrollment system 409 approves or denies the user from participating in the program. If the user is approved, the authorization data may also include data for information relating to amount of subsidy to be provided to the user. If the user is denied, the authorization data may also include data indicating reasons for denial (e.g., erroneous personal information, duplicate household applied to the program, invalid address, proof of eligibility needed, etc.). The authorization data obtained from the verification system 408 and/or enrollment system 409 is also stored in the database 406 and associated with the corresponding unique identifier (e.g., Order ID) for the order. Optionally, the authorization data obtained from the verification system 408 and/or enrollment system 409 may be transmitted to the device 402 to provide the user with a receipt containing a barcode or a QR code, as discussed further below.

If the authorization data indicates that the user is approved for participation in the program, then the method 500 proceeds to step 516. In step 516, the sign-up system 407 provides the device 402, from which the order for the user originated, the authorization data. The device 402 may display an output, via the user interface 106, indicating that the user's order has been approved proceed to transact with the user to provide subsidized telecommunication device and/or service and enrollment. In step 516, the system 400 enrolls the user in the program and transacts with the user to provide subsidized or free telecommunications device and/or service. For example, if the order is approved by the verification system 408 and/or enrollment system 409, then then the system 400 enrolls the user into ACP and/or Lifeline via NLAD or via state specific portal, for example, for CA, OR or TX, or other government telecommunications subsidy program, and the system 400 provides the user with subsidized or free telecommunications device and/or service.

Step 516 may comprise any suitable method for providing the user with a free telecommunications device and/or service or for providing the user with a subsidized telecommunications device and/or service. In one example, step 516 comprises method 600 for transacting with a user to provide subsidized telecommunications device and/or services via a kiosk 200, discussed further below. In another example, step 516 comprises a method 700 for transacting with a user to provide subsidized telecommunications device and/or services via a vending machine 300, also discussed further below. In a further example, the user can select via the user interface 106 to have the subsidized telecommunications device mailed to a specific location. In another example, the user may be enrolled to a program for subsidized services, in particular, telecommunications services without the need for a separate telecommunications device connected to the subsidized service.

After the device 402 provides the user with a subsidized telecommunications device and/or service or a receipt for obtaining a subsidized telecommunications device and/or service, the method 500 may optionally include step 522 and/or 524, in no particular order. In step 522, the device 402 may output a prompt via the user interface 106 to request the user to input for completing a survey regarding the user's experience with the device 402. Feedback data collected from the survey may be used to improve the device 402. In step 524, the device 402 may dispense marketing materials to the user after the user completes the application and receives a subsidized telecommunications device and/or service or a receipt for obtaining a subsidized telecommunications device and/or service. In some examples, the marketing materials may be dispensed to the user simultaneously with providing the user with a subsidized telecommunications device and/or service or a receipt for obtaining a subsidized telecommunications device and/or service.

In some examples, if the authorization data indicates that the user is ineligible from participating in the program, then the sign-up system 407 provides the device 402, from which the order for the user originated, the authorization data (step 525). The device 402 may display an output, via the user interface 106, indicating that the user's order is ineligible from participating in the program. If the authorization data indicates that the user is denied from participating in the program, then the method proceeds to step 518. In step 518, the sign-up system 407 provides the device 402, from which the order for the user originated, the authorization data. In some examples, the device 402 may display an output, via the user interface 106, indicating that the user's order has been denied. In other examples, the device 402 does not indicate to the user that the application is rejected. Instead, the system 400 allows the user to continue modifying the existing information or providing additional information in an effort to remedy the denied application. In particular, the device 402 does not display an output indicating that the user's order has been denied, but instead, displays an output indicating that additional information is required.

As discussed further below, the method 500 iteratively provides instructions to solicit additional input from the user to assist the user in obtaining approval from the verification system 408 and/or enrollment system 409 for participating in the program. The additional input may be for additional data/information and/or for modifying existing data/information stored in the database 406 and/or for providing additional data/information to address the denial from the verification system 408 and/or enrollment system 409. The authorization data transmitted from the sign-up system 407 to the device 402 may include data for information relating to reasons for denial. Based on the authorization data, the device 402 may display an output, via the user interface 106, and/or provide printed instructions, via the printer (which may be part of delivery component 114), instructions, links and/or codes (e.g., QR codes for links or Order ID) for the user to follow to provide additional inputs to modify data and/or information previously transmitted to the sign-up system 407 or to provide additional data and/or information to remedy the denial. For example, the instructions displayed on the user interface 106 may request that the user upload additional documents needed to remedy the denial. The instructions may also instruct the user to contact customer support for assistance in completing the application. The customer support may be a live customer support chat via the user interface 106, or the user may also access customer support on a live phone or video call via the user interface 106.

In addition to or alternatively, the instructions may direct the user to provide further document data corresponding to additional documents needed to remedy the denial.

In one example, the authorization data may indicate that the new order was denied for one or more of the following rejection types:
(1) personal information rejection;
(2) duplicate household rejection;
(3) invalid address rejection;
(4) not eligible for transfer until next calendar month rejection; and
(5) eligibility rejection.
   Although this paragraph describes examples of different rejection types, the listing above is provided as examples and is not exhaustive of the types of rejections that may be indicated in the authorization data. The method of 500 may also be used to address other types of rejections in similar manners as discussed further below.

A personal information rejection arise when the verification system 408 and/or the enrollment system 409 is unable to identify the user based on the data for personal information (e.g., name, date-of-birth or other types of personal information) provided or may indicate that the personal information provided is erroneous. To remedy a personal information rejection, the user may be instructed in step 518 to provide additional inputs to modify data and/or information previously transmitted to the sign-up system 407. The user may also upload documents verifying that input data previously provided is are correct.

A duplicate household rejection may arise when the enrollment system 409 has identified another member of the same household as the user to have enrolled in the program. To remedy a duplicate household rejection, the user may be instructed in step 518 to provide additional data and/or information (e.g., data for a household worksheet) to remedy the denial.

An invalid address rejection may arise when the verification system 408 has indicated that data for the user's address provided is erroneous. To remedy an invalid address rejection, the user may be instructed in step 518 to provide additional inputs to modify data and/or information previously transmitted to the sign-up system 407. These additional inputs may be obtained by device 402 in step 519. For example, the device 402 may prompt the user to confirm or modify the invalid address previously provided to the sign-up system 407 and stored in the database 406.

A not eligible for transfer until next calendar month rejection may be remedied by providing additional information, such as choosing an exception code. The additional information obtained to remedy this denial does not modify data and/or information previously transmitted to the sign-up system 407.

An eligibility rejection may arise when the verification system 408 has indicated that additional proof of eligibility is needed for approval of the user's participation in the program. To remedy an eligibility rejection, the user may be instructed in step 518 to provide further document data corresponding to documents for remedying the denial.

For rejections where additional forms/inputs are needed to resolve the rejections, the forms may be transmitted by the sign-up system 407 to the device 402 and outputted on a user interface 106 to prompt input in response from the user to complete the form. Once the user provides inputs to device 402, the information obtained for the form is transmitted from the device 402 to the sign-up system 407 and subsequently transmitted by the sign-up system 407 to the verification system 408 and/or the enrollment system 409 where the user's information may be reprocess in step 510.

If the instructions provided to the user requests additional inputs to modify data and/or information previously transmitted to the sign-up system 407 or to provide additional data and/or information to remedy the denial, then the method proceeds to step 519. In step 519, the device 402 obtains additional input data for modifying data and/or information previously transmitted to the sign-up system 407 based on data for information relating to reasons for denial. For example, the user interface 106 may display questions or present open fields to solicit additional input data from the user in a similar manner as described above for step 506. The device 402 may display, via a user interface 106, instructions and/or forms for obtaining additional input data from the user for modifying data and/or information previously transmitted to remedy the denial. In addition to or in the alternative, the device 402 may display, via a user interface 106, instructions and/or forms for obtaining additional input data from the user to provide additional data and/or information (e.g., data for a household worksheet) to remedy the denial. The additional input data for modifying data and/or information previously transmitted to the sign-up system 407 may be stored in the database 406 corresponding with the corresponding unique identifier (e.g., Order ID) for the order. The additional provided information provided to remedy the denial may be transmitted to the sign-up system 407 and stored in the database 406.

After the user provides additional data and/or information to remedy the denial in step 519, the method 500 returns to step 510 and generates a new authorization request for approval for the user to participate in the program. The new authorization request is based on data stored in the database 406 with the corresponding unique identifier (e.g., Order ID) for the order. The data stored in the database 406 may comprise the initially provided input data, as modified and/or supplemented by the additional data and/or information provided in step 519. As the method 500 continues to step 512, the new authorization request is transmitted by server 405 of the sign-up system 407 to the verification system 408 and/or enrollment system 409 for evaluating the user's eligibility to participate in the program.

If the instructions provided requests that the user provide document data corresponding to documents needed to remedy the denial, then the method proceeds to step 520. The instructions may direct the user to provide the document data to the sign-up system 407 based on data for information relating to reasons for denial, using any suitable method, as discussed further below in step 520. In step 520, the sign-up system 407 receives document data corresponding to documents needed to remedy the denial from the device 402 and/or from other sources, as the user is directed by the instructions provided in step 518. The document data received by the sign-up system 407 may optionally be stored in the database 406 with the corresponding unique identifier (e.g., Order ID) for the order. Then or simultaneously, the document data may be sent to the verification system 408 and/or enrollment system 409 for review in an authorization request in order to obtain approval for the user for the program. In one particular embodiment, the enrollment system 409 does not provide denials that would require the user to provide document data, and therefore, the document data may be sent to the verification system 408, and not the enrollment system 409, for review in an authorization request in order to obtain approval for the user for the program.

In one example, the user may provide the document data to the sign-up system 407 by providing documents for remedying the order for the program to the device 402, and the device 402 generates and subsequently transmits document data corresponding to documents provided by the user. In one example, the device 402 may display, via a user interface 106, instructions for the user to provide document(s) for remedying the order for the program. In particular, the user may provide physical document(s) to a document scanner 116 of the device 402. The document scanner 116 generates image data corresponding to an image of a document provided by the user. The processor 102 of the device 402 may generate document data comprising data corresponding to the document based on the image data—for example, the processor analyze the image data to identify text contained therein. In other embodiments the document data comprises the image data. The document data received by the sign-up system 407 from the device 402 may optionally be stored in the database 406 with the corresponding unique identifier (e.g., Order ID) for the order. Then or simultaneously, the document data may be sent to the verification system 408 for review in an authorization request in order to obtain approval for the user for the program.

Alternatively or in addition, the user may provide document data to the sign-up system 407 by inputting a reference for retrieving document data corresponding to document(s) for remedying the order for the program to the device, and the device 402 transmits the reference to the sign-up system 407. The document data may also be retrieve using personal data of the user without inputting a reference for retrieving the document data. The sign-up system 407 subsequently provides the reference or personal data to a documents database 414 and retrieves document data corresponding to the reference from the documents database 414. For example, the device 402 may display, via a user interface 106, instructions for the user to provide a reference for retrieving document data corresponding to document(s) for remedying the order for the program. In response, the user may provide a reference for retrieving document data to the device 402. The reference may be an identifier or access credentials for retrieving document(s) associated with the user from a documents database 414, which is subsequently transmitted to the sign-up system 407. The sign-up system 407 may utilize the reference corresponding to document data received from the device 402 and transmit said reference to a documents database 414 and retrieve associated document data identified based on the reference provided. The document data received by the sign-up system 407 from the documents database 414 may optionally be stored in the database 406 with the corresponding unique identifier (e.g., Order ID) for the order. Then or simultaneously, the document data may be sent to the verification system 408 for review in an authorization request in order to obtain approval for the user for the program.

In an alternative example, document data for the user may be retrieved by the sign-up system 407 based on personal information provided by the user. The personal information (e.g., social security number) may be used for retrieving document data corresponding to document(s) for remedying the order for the program from the documents database 414. The document data may be retrieve using personal data of the user without inputting a reference for retrieving the document data. The sign-up system 407 may utilize the personal data of the user received from the device 402 and transmit said data to a documents database 414 and retrieve associated document data identified based on the personal data of the user. The document data received by the sign-up system 407 from the documents database 414 may optionally be stored in the database 406 with the corresponding unique identifier (e.g., Order ID) for the order. Then or simultaneously, the document data may be sent to the verification system 408 for review in an authorization request in order to obtain approval for the user for the program.

The user may also provide the document data separate from the device 402. For example, the sign-up system 407 may also obtain document data by a user providing copies of documents to a human representative, as directed by the instructions provided in step 518. The user may be directed to or have an option to provide document data to the sign-up system 407 by providing copies of documents to a human representative, as directed by the instructions provided in step 518. The human representative may scan the documents to generate document data corresponding to images of such documents and transmit the document data to the sign-up system 407. The document data received by the sign-up system 407 from the human representative may be stored in the database 406 with the corresponding unique identifier (e.g., Order ID) for the order. Then or simultaneously, the document data may be sent to the verification system 408 for review in an authorization request in order to obtain approval for the user for the program.

In another example, the sign-up system 407 may also obtain document data by a user uploading document data corresponding to images of such documents to a secure link connected to the sign-up system 407, as directed by the instructions provided in step 518. The secure link may be provided to the user by the device 402. For example, the secure link may be provided on a receipt printed by a printer of the device 402. In one particular example, in step 518, a printer within the delivery component 114 of the device 402, may provide a receipt having instructions or a QR code associated with the user's Order ID. In this example, the user may scan the QR code using any suitable device, such as a mobile device. The QR code may direct the user to a secure website that provides instructions for the user to upload images of required documents for the application. In another example, the user may receive a secure link and/or QR code as a text or email. This may be sent to a telephone number or an email provided by the user and stored in database 406. The document data received by the sign-up system 407 via the secured link may optionally be stored in the database 406 with the corresponding unique identifier (e.g., Order ID) for the order. Then or simultaneously, the document data may be sent to the verification system 408 for review in an authorization request in order to obtain approval for the user for the program.

After the user provides document data corresponding to documents needed to remedy the denial in step 520, the method 500 proceeds to step 521. In step 521, the user is required to have a waiting period of a predetermined amount of time before returning to step 504 to revisit and complete the application. The waiting period may be from 1 minute to 10 minutes, 1 minute to 5 minutes, or 1 minute to 2 minutes. The waiting period provides time to allow the verification system 408 to review the uploaded documents. The user may leave the device 402 during the waiting period and return to steps 502 and 504 to revisit the application after the waiting period has expired. In some cases, the verification system 408 may need more than 10 mins to review the uploaded documents. Therefore, the user may need to revisit the device 402 to continue with method 500 at a later time.

In step 504, the device 100 obtains, via the user interface 106, a unique identifier of the user. In particular, the unique identifier corresponds to an order previously initiated by the user communicating via any suitable device with the server 405, such as an Order ID for the previously initiated order. The previously initiated order may be an order initiated via a device 402 of the system 400 (i.e., step 506) as described above. The previously initiated order may also be an order previously initiated by the user via other suitable means with the sign-up system 407. In one example, the previously initiated application may have been initiated online via a personal computer connected to the server 405 of the sign-up system 407. Alternatively, the previously initiated application may have been initiated with a street representative that intakes data from the user and provides the data to the sign-up system 407. It is contemplated that the previously initiated application may be initiated by any suitable manner for transmitting the user's order to the sign-up system 407. The information collected from the user is stored in database 406 along with a corresponding unique identifier, as discussed further below.

The unique identifier (e.g., Order ID) may be inputted by the user via the user interface 106, e.g., input via touchscreen or keyboard. Alternatively, the unique identifier (e.g., Order ID) may be provided by the user via a receipt containing a barcode or a QR code (which may be obtained in step 512 or step 518 as discussed above). The user may scan the barcode or QR code with a code scanner to provide the unique identifier (e.g., Order ID) to the device 402. After obtaining the unique identifier (e.g., Order ID) from the user, the device 402 transmits the unique identifier (e.g., Order ID) to the sign-up system 407 and the method proceeds to step 510.

It is noted that a user may approach a device 402 in any location (e.g., any one of the devices 402 in system 400) and retrieve a previously initiated order initiated at any other device 402 in the system 400. The device 402 may also be able to retrieve previously initiated order initiated via a personal computer, with a street representative, or any other suitable means for initiating an order with the sign-up system 407. The use of an Order ID for retrieving previously initiated orders may serve to reducing duplicate orders for a single user and allows for continuity of the order process from any of the devices 402 in the system 400.

In step 504, the system 400 may optionally verify the identity of the user while the user is interacting with the device 402 and providing input data to the device 402. To verify the identity of the user, the device 402 may capture images of the user using a camera 118 or a facial recognition scanner 122 to generate facial data corresponding to facial images and/or features of the user. The facial data generated by the device 402 is compared to a previously obtained facial data associated with a unique identifier (e.g., Order ID) for a previously initiated order. The previously obtained facial data may be facial data obtained from a previous interaction of the user with the device 402. For example, the device 402 may transmit the facial data to the sign-up system 407 for verification of the identity of the user. The sign-up system 407 may retrieve the previously obtained facial data associated with the previously initiated order from the database 406 and compare the newly generated facial data to confirm identity of the user. Alternatively, the sign-up system 407 may retrieve the previously obtained facial data associated with the previously initiated order from the database 406 and provide the facial data associated with the previously initiated order from the database 406 to the device 402 to compare the newly generated facial data to confirm identity of the user. If newly obtained facial data corresponds to the previously obtained facial data, the method 500 proceeds to step 510. If the newly obtained facial data does not correspond to the previously obtained facial data, the method 500 terminates and the user is not permitted to continue with the application to prevent fraudulent activity. In another example, the device 402 may transmit the facial data to the sign-up system 407 and the sign-up system 407 may transmit the facial data to a third party system (not-shown) for verification of the identity of the user.

In one example, the previously initiated order may be a fully completed order, where the user has provided all required information to apply for the program. The previously initiated order may have been completed upon the user's initial interaction with the device 402, or may have been completed following a denial from the verification system 408 and subsequently remedied via steps 518, 519 and/or 520. For users having a complete previously initiated order, the sign-up system 407 retrieves data stored within the database 406 corresponding to the unique identifier (e.g., Order ID) for a previously initiated order received from the device 402 (for example, the unique identifier having been provided by the user via the device 402 and transmitted to the sign-up system 407 from the device 402) and generates an authorization request for approval for the user to participate in the program based on the data retrieved from the database 406 (step 510). The authorization request is transmitted from the sign-up system 407 to the verification system 408 and/or enrollment system 409 for evaluating whether the user is eligible for participation in the program and method 500 continues in the manner as described above.

In another example, the previously initiated order may be a partially completed order, where additional information may be obtained from the user. The method 500 may proceed to step 506 to obtain input data from the user. The input data corresponds to data needed to fully complete the order. After the user provides all the required information, the method 500 continues to step 510.

The method 500 can continue until the user is approved in step 512. If the user is denied again, the method 500 continues to step 518 to provide additional information and support until the user is approved. Furthermore, throughout the method 500, a user support resource (e.g., customer support chat or customer support telephone line) may be available to the user via the user interface 106 or by telephone to further provide instructions in addition to those provided in step 518 to resolve or remedy the denial.

In one example, in step 525, if the authorization data indicates that the user is ineligible from participating in the program or if the user elects not to remedy a denial by the verification system 408 and/or enrollment system 409, then the sign-up system 407 provides the device 402, from which the order for the user originated, the authorization data. In those situations where the user elects not to remedy a denial by the verification system 408 and/or enrollment system 409, the user may be provided with a receipt via a printer 214, 315 that contains a QR code containing the order's unique identifier (e.g., Order ID). Similarly, when the authorization data indicates that the user is ineligible from participating in the program, the user may also be provided with a receipt via a printer 214, 315 that contains a QR code containing the order's unique identifier (e.g., Order ID). The user may use the receipt and return to a device 402 at a later time to step 504 to return to the same order. The device 402 may display an output, via the user interface 106, indicating that the user's order is ineligible from participating in the program. Optionally, the device 402 prints and provides marketing/promo materials to the user, similar to step 524.

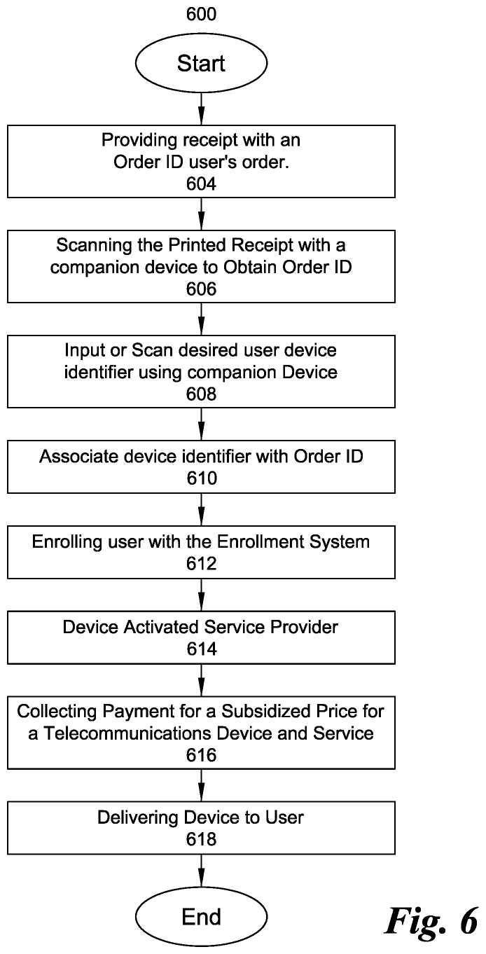

FIG. 6 shows an exemplary method 600 for transacting with a user to provide subsidized telecommunications devices and services via a device 402, such as a kiosk 200, discussed further below. The exemplary method 600 may also be applicable to a vending machine 300. Step 604 continues from step 512 shown in method 500. In the exemplary method 600, a plurality of companion devices 412 that can be located anywhere are used by agents (e.g., salesperson or store owner) to help complete the delivery of subsidized telecommunications devices and/or services to users. In step 604, the device 402 (e.g., kiosk 200) prints a receipt via a printer 214, 315 that contains a QR code containing the order's unique identifier (e.g., Order ID). The device 402 and/or the receipt may include output prompting the user to take the printed receipt containing the QR code to an agent having a companion device 412.

In step 606, the agent scans the receipt containing the QR code with a companion device 412 to obtain the order's unique identifier (e.g., Order ID). The companion device 412 transmits the order's unique identifier (e.g., Order ID) to the sign-up system 407 to retrieve authorization corresponding to the unique identifier. The sign-up system 407 transmits the authorization data to the companion device 412 and the companion device 412 may generate an output generated based on the authorization data (e.g., confirmation that the user is approved, a list of different devices authorized and/or amount of co-pay for each device, etc.).

In step 608, the agent may provide input to the companion device 412 a device identifier for the telecommunications device to be provided to the user. For example, the agent may scan a barcode or QR code on the telecommunications device with the companion device 412 to input the device identifier to the companion device, or the agent may manually input the device identifier for the telecommunications device to the companion device 412. In step 610, the companion device 412 transmits the device identifier to the sign-up system 407, which associate the device identifier with the order's unique identifier (e.g., Order ID) and stores the device identifier in the database 406 associated with the corresponding unique identifier (e.g., Order ID) for the order.

Although steps 608 through 616 are shown in FIG. 6 in a particular order, it is contemplated that these steps may be performed in method 600 in any order. In step 612, the sign-up system 407 transmits an enrollment request, the enrollment request may comprise data corresponding to the unique identifier (e.g., Order ID) to the enrollment system 409 to enroll the user to the program. In some embodiments, the enrollment system 409 may either accept or reject enrollment of the user to the program. For example, the enrollment system 409 may confirm with the verification system 408 that the user is authorized to enroll in the program. If the enrollment system 409 rejects enrollment of the user to the program, then method 600 is discontinued and method 500 returns to step 518. In step 614, the sign-up system 407 may transmit the device identifier to a service provider to activate the telecommunications device with a service, if such a service is authorized and provided by the program. In some embodiments, the user may be provided with the telecommunications device and/or service without having receiving an authorization for the program based on additional criteria (e.g. policies and pricing criteria) applied by the sign-up system 407. In step 616, the companion device 412 directs the agent to collect payment from the user for the subsidized telecommunications devices and/or services, if a co-pay for the subsidized telecommunications devices and/or services is determined to be needed based on the authorization data retrieved from the database 406. In some embodiments, the user may be provided with the telecommunications device and/or service without providing a co-pay based on additional criteria (e.g. policies and pricing criteria) applied by the sign-up system 407. If a co-pay is not needed, the method 600 skips step 616. Payment may be collected using any suitable device for receiving payment from the user. For example, payment may be collected using a credit card reader, a cash (e.g., bills or coins) acceptor, a scanner for receiving payment codes via a payment service (e.g., Cashap, Paypal, Venmo, etc.) or a combination thereof. In some embodiments, step 610 occurs before step 612 and the device identifier is included in the data transmitted to the enrollment system 409. In other embodiments, the device identifier is stored in the database 406, but is not transmitted to the enrollment system 409.

In step 618, the telecommunications device, and if applicable, that is activated with a telecommunications service, is delivered to the user. If the user selects to have the subsidized telecommunications device mailed to a specific location, then step 618 may comprise delivery of the telecommunications device to the user external to system 400.

If the user is enrolled for only subsidized telecommunications services without the need for a telecommunications device connected to the subsidized service, then steps 614 to 618 may be omitted. The subsidized telecommunications services may be delivered to a specific location, external to system 400. In another example, if the user is enrolled for only subsidized telecommunications services without the need for a telecommunications device connected to the subsidized service, then steps 614 and 616 may remain in method 600, while step 618 is omitted.

In addition to using the companion device 412 in the manner described above, agents can also use the companion devices 412 to request more inventory, marketing material, kiosk supplies, or other assistance. The agent may select new requests for inventory on the companion device 412 and select desired product to replenish.

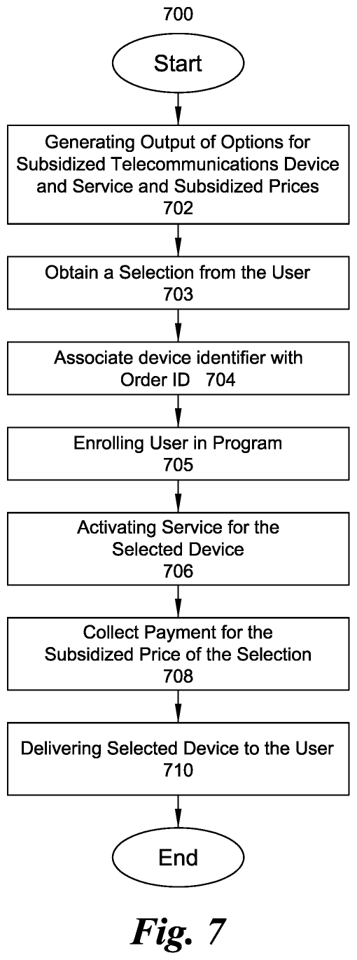

FIG. 7 shows an exemplary method for transaction with a user to provide subsidized goods or services via a vending machine 300, according to an exemplary embodiment of the present application. The vending machine 300 further comprises a dispensing mechanism 314 for selecting and dispensing a subsidized or free good to a qualified user. Step 702 continues from step 512 shown in method 500.

In step 702, the vending machine 300 generates, via the user interface 106, an output of options for subsidized telecommunications devices and/or services and corresponding subsidized prices based on the authorized data provided by the sign-up system 407. The vending machine 300 may further output, via the user interface 106, prompts that request selection of an option by the user. The subsidized telecommunications device and/or service may have different prices depending on the amount of subsidy approved for the user, as indicated in the authorization data. In some embodiments, the amount of subsidy may be determined based on additional criteria (e.g. policies and pricing criteria) applied by the sign-up system 407. In step 703, the user may select an option of a subsidize telecommunications device to be obtained from the vending machine 300 via the user interface 306. For example, the user interface 106 obtains input from the user selecting one of the options for subsidized telecommunications devices and/or services.

Although steps 704 through 708 are shown in FIG. 7 in a particular order, it is contemplate that these steps may be performed in method 700 in any order.

In step 704, the vending machine 300 obtains a device identifier of a telecommunications device selected by the user and transmits the device identifier to the sign-up system 407, which associates the device identifier with the order's unique identifier (e.g., Order ID) and stores the device identifier in the database 406 associated with the corresponding unique identifier (e.g., Order ID) for the order. In step 705, the sign-up system 407 transmits data corresponding to the unique identifier (e.g., Order ID) to the enrollment system 409 to enroll the user to the program. In some embodiments, the enrollment system 409 may either accept or reject enrollment of the user to the program. For example, the enrollment system 409 may confirm with the verification system 408 that the user is authorized to enroll in the program. If the enrollment system 409 rejects enrollment of the user to the program, then method 700 is discontinued and method 500 returns to step 518.

In some embodiments, step 704 occurs before step 705 and the device identifier is included in the data transmitted to the enrollment system 409. In other embodiments, the device identifier is stored in the database 406, but is not transmitted to the enrollment system 409.

In step 706, the sign-up system 407 may optionally transmit the device identifier to a service provider to activate the telecommunications device with a service, if such a service is authorized and provided by the program (or otherwise authorized by the sign-up system 407 base on additional criteria (e.g. policies and pricing criteria as discussed above). If activation of subsidized (e.g., free or discounted) telecommunications device fails, the vending machine 300 will internally send an alert to a vending machine agent and prompt the user via the user interface 106 to select another subsidized (e.g., free or discounted) telecommunications device.

In step 708, the vending machine 300 collect payment from the user, via the payment device 312, for the subsidized telecommunications devices and/or services, if a co-pay for the subsidized telecommunications devices and/or services is determined to be needed based on the authorization data retrieved from the database 406. If a co-pay is not needed, the method 700 skips step 708. The user interface 306 of vending machine 300 prompts the user for payment of the subsidized price for the selected option of subsidized telecommunications device and/or services. The user may provide payment to the vending machine 300 via a payment device 312. The payment device 312 may be any suitable device for receiving payment from the user. For example, the payment device 312 may be a credit card reader, a cash (e.g., bills or coins) acceptor, a scanner for receiving payment codes via a payment service (e.g., Cashap, Paypal, Venmo, etc.) or a combination thereof.

In step 710, the vending machine 300 dispenses the telecommunications device, and if applicable, that is activated with a telecommunications service, via the dispensing mechanism 314 to the user.

If the user selects to have the subsidized telecommunications device mailed to a specific location, then step 706 to 710 may be omitted and the telecommunications device may be delivered to the user external to system 400. If the user is enrolled for only subsidized telecommunications services without the need for a telecommunications device connected to the subsidized service, then steps 706 to 710 may be omitted. The subsidized telecommunications services may be delivered to a specific location, external to system 400. In another example, if the user is enrolled for only subsidized telecommunications services without the need for a telecommunications device connected to the subsidized service, then steps 706 and 708 may remain in method 700, while step 710 is omitted.

In another example, the vending machines 300 may be used in method 600 in conjunction with a plurality of agents (e.g., salesperson or store owner) having companion devices 412, as described above. In a further example, vending machines 300 and/or agents having companion devices 412 serve as pick-up locations for users who have obtained a successful enrollment using other devices (for example, kiosks 200 or vending machine 300) in system 400, or from using other enrollment methods, such as via a website or phone system that transmits personal data of the user to the sign-up server 407. In one example, if the initial vending machine 300 with which a user interacted does not have the user's desired product, the user can arrange to pick up their device at different vending machine 300 or with a specific agent with a companion device 412. Upon obtaining approval for enrollment in the program, the user may be requested to select a pickup location (e.g., a specific vending machine 300 or a specific agent with a companion device 412). After the user selects a pickup location, the user may be provided with a corresponding unique identifier (e.g., Order ID) for the order or link, e.g., a link or a QR code for a secure site corresponding to data correlated to the user's order ID that can be inputted or scanned by the vending machine 300 and/or companion device 412, in a similar manner as described above with respect to step 606. Upon inputting the unique identifier (e.g., Order ID), the vending machine 300 may deliver an activated subsidized telecommunication device to the user via the dispensing mechanism 314 according to method 700.

### EXAMPLE

### Example 1

Example 1 provides vending machines for dispensing tablets, SIM cards, or phones to customers for ACP and Lifeline.

The overall concept of the machines of Example 1 are that they comprise free or subsidized cost Internet and phone service machines and/or subsidized/free devices. The machines may be placed everywhere and anywhere a qualifying population is found. Some examples of this can be malls, churches, government program offices, train/subway stations, bus stops, thrift shops, red cross locations etc.

The machines may be capable of:
New applications. Full enrollment process at one time.
Completion/enrollment of applications started by the customer, in the National Verifier (NV) or equivalent state-specific portal. These applications can be completed directly with the NV, or equivalent state-specific portal, via their website, or through other service providers.
Pickup location for applications submitted and enrolled through our different signup methods, such as website or phone system.

Features of the vending machine include:
Privacy display for customer security.
Document scanner to upload documents for customers. Documents can be uploaded for general use or for submittance to NV to obtain application approval. Scanned documents should be stored in the customer's profile.
Automatic pictures and recording of customer to ensure no fraudulent activity.
Ability for customer to share their experience and provide feedback, after completing their vending machine experience.
Ability for machine to dispense marketing materials after the customer's session completes.

Future uses of the machine can include giveaways, promotions, referrals, etc.

The vending machine may have 3 functions:

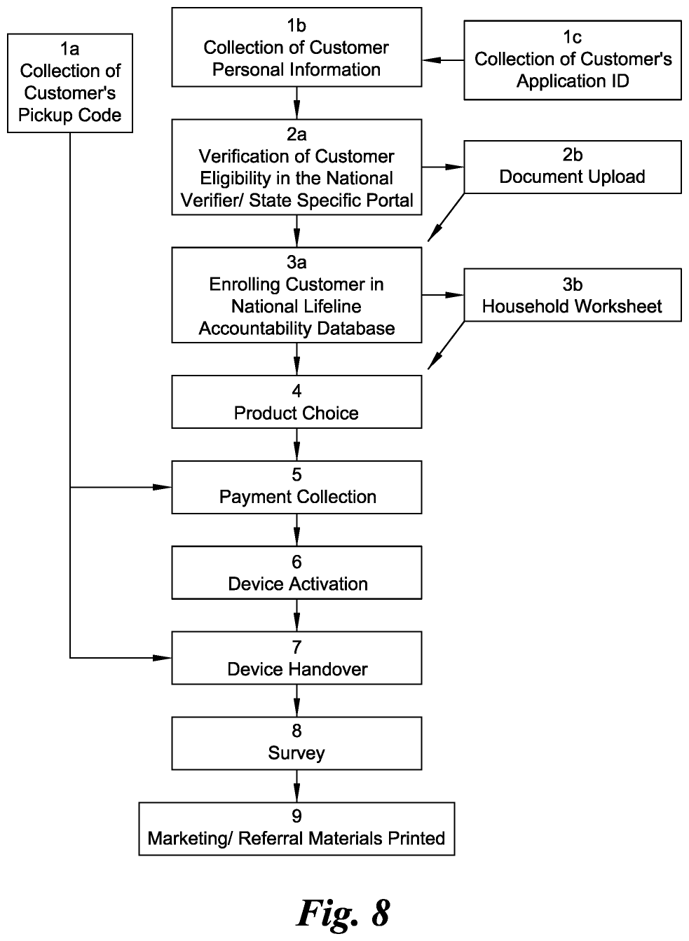

### 1. New Applications—1b in Flowchart of FIG. 8

a. Customer can approach the machine and apply for either ACP (or any similar program) or Lifeline.
   i. Customer information is collected as required based on the program the customer is applying for.
   ii. The application is filled out directly on the machine screen.
   iii. The machine can work with Telgoo5, Unavo, or NV and NLAD directly.
b. Customer application is either approved or rejected by the NV.
   i. Exceptions:
      1. California, Oregon, Texas perform application process in their own portal.
   ii. Approved: Skip to c.
   iii. Rejected:
      1. If customer application requires document upload, customer can upload documents in the vending machine.
         a. Documents are kept on file in the customers application, in case needed for future use.
      2. Machine will list clear instructions of acceptable documents for upload.
      3. Customer can also call a support line to complete the application with an agent.
      4. Customer will be required to wait a few minutes before proceeding with the application. After wait time has passed, customer will need to search for their application and check for approval.
         a. If approved, continue with c.
         b. If rejected, customer can continue to follow the procedure in b.iii. until approved.
c. Customer is enrolled into ACP or Lifeline via NLAD.
   i. Exceptions:
      1. California, Oregon, Texas perform enrollement process in their own portal.
         a. Exception to exception: California subscribers receiving broadband only are enrolled in NLAD.
   ii. Approval: Continue below with d.
   iii. Rejection:
      1. Device benefit received: continue below with d.
      2. Duplicate address: customer must fill out duplicate address form, customer can do so on vending machine. Continue with c.ii. [above, aka continue with d. below.]
d. Customer can choose a product.
   i. Tablet price differs if customer fits into 1.c.iii. 1.
e. Upon product choice, payment will be collected from the customer, if applicable.
   i. Credit card.
   ii. Cash.
   iii. Other methods.
      1. Cashap.
      2. Paypal.
      3. Venmo.
      4. Etc.
f. Upon successful payment, the chosen device will be activated.
   i. Should device activation fail:
      1. the customer will be requested to choose another device.
      2. An automatic alert should be sent to the vending machine management team.
   ii. We can port the customers phone number over to their new sim card, should they want us to.
g. Upon device activation, chosen product will vend for the customer.
h. Survey option will display.
i. Promotional and informational materials should also dispense with the product.

### 2. Completion/Enrollment Of Application Started In The National Verifier—1c in Flowchart

a. Customer applies for the benefit through the National Verifier directly or through another service provider.
b. Customer provides their application ID to the vending machine.
c. Follow 1.a.i. to 1.i. listed above.

### 3. Pickup Location For Applications Enrolled And Completed Through Different Signup Methods, Such As Website Or Phone System—1a in Flowchart

a. Customer applies for the program via our phone system or website.
b. Customer is notified whether they need any documents to qualify.
c. Once qualified, customer is provided with a pickup code.
d. Customer inputs pickup code into vending machine.
e. Vending machine dispenses product.

Those skilled in the art will understand that the exemplary embodiments described herein may be implemented in any number of manners, including as a separate software module, as a combination of hardware and software, etc. For example, the exemplary methods may be embodiment in one or more programs stored in a non-transitory storage medium and containing lines of code that, when compiled, may be executed by one or more processor cores or a separate processor. A system according to one embodiment comprises a plurality of processor cores and a set of instructions executing on the plurality of processor cores to perform the exemplary methods discussed above. The processor cores or separate processor may be incorporated in or may communicate with any suitable electronic device, for example, on board processing arrangements within the device or processing arrangements external to the device, e.g., a mobile computing device, a smart phone, a computing tablet, a computing device, etc., that may be in communications with at least a portion of the device.

The invention described and claimed herein is not to be limited in scope by the specific embodiments herein disclosed since these embodiments are intended as illustrations of several aspects of this invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed is:

1. A system for enrolling a user to a program for a government subsidized telecommunications device and service comprising:
a database for storing application data related to a plurality applicants with their corresponding unique identifiers, each unique identifier corresponding each one of the plurality of applicants;
a server configured to be connected to the database and a government verification system for determining whether the user is eligible for enrollment into the program; and
one or more of a device, the comprising:
a user interface for displaying output and receiving input from the user, and
a transceiver configured to receive, via a communications network, data from the government verification system and transmit data to the government verification system; and
a processor and a non-transitory computer readable storage medium including a set of instructions executable by the processor, the set of instructions operable to:
obtain, via a user interface, an input corresponding to a status of an application for the program;
obtain, via the user interface, an identifier and retrieving, via a communications network, an existing application corresponding to the identifier from the database, via the server, when the status indicates the application was previously initiated, and initiate a new application for the program when the status indicates the application for the program was not previously initiated;
obtain, via the user interface, input data from the user for completing the application for the program when a new application is initiated or when the previously initiated application for the program was not previously completed; and
transmit, via a communications network, the input data to the server, and
wherein the server comprises a processor and a non-transitory computer readable storage medium including a set of instructions executable by the processor, the set of instructions operable to:
generate an authorization request based on the input data, the existing application, or a combination thereof,
transmit, via a communications network, the authorization request to the government verification system to determine eligibility of the user for the program based on the input data, and
obtain from the government verification system, via the communications network, authorization data indicating whether the user is approved or denied, wherein if the user is approved the authorization data further comprises an amount of subsidy approved for the user.

2. The system of claim 1, wherein the system comprise two or more device, wherein each device is at a location convenient to potentially eligible users.

3. The system of claim 2, wherein the location is selected from a group consisting of malls, churches government program offices, train stations, subway stations, bus stops, thrift shops, Red Cross locations, convenience stores, and laundromats.

4. The system of claim 1, wherein the set of instructions of the device is further operable to generate a printed receipt comprising a unique identifier corresponding to the authorization data.

5. The system of claim 1, wherein the device comprises a printer, and the set of instructions is further operable to direct the printer to generate a printed receipt comprising the unique identifier; and
wherein the database receives the authorization data and stores the authorization data with a unique identifier corresponding to the user in the database.

6. The system of claim 1, wherein the system further comprises a mobile device comprising a scanner configured to scan the printed receipt to obtain the unique identifier, and a transceiver for transmitting the unique identifier to a server to retrieve the authorization data from the database and receiving the authorization data from the server.

7. The system of claim 1, wherein the device further comprise a payment device and the set of instructions is further operable to:
generate an output, via the user interface, comprising options for subsidized telecommunications devices and services and corresponding subsidized prices based on the amount of subsidy approved for the user when the authorization data indicates the user is approved,
obtain, via the user interface, a selected telecommunications device and service from the options for subsidized telecommunications devices and services,
collect payment, via the payment device, from the user for the subsidized price corresponding to the selected telecommunications device and service,
communicate, via the communications network, with a service provider to request activation of the selected telecommunications device and service, and
deliver the selected telecommunications device and service to the user.

8. The system of claim 1, wherein the server is further configured to be connected to an enrollment system for enrolling the user into the program, and
wherein the set of instructions executable by the processor of the server is further operable to:
transmit, via a communications network, an enrollment request to the enrollment system to enroll the user into the program, the enrollment request is based on the input data.

9. A method for enrolling a user to a program for a subsidized telecommunications device and service, the method comprising:
obtaining, via a user interface, an input corresponding to a status of an application for the program;
obtaining, via the user interface, an identifier and retrieving, via a communications network, an existing application corresponding to the identifier from a sign-up system when the status indicates the application was previously initiated, and initiating a new application for the program when the status indicates the application for the program was not previously initiated;
obtaining, via the user interface, input data from the user for completing the application for the program when a new application is initiated or when the previously initiated application for the program was not previously completed;
transmitting, via a communications network, the input data to the sign-up system to generate an authorization request based on the input data, the existing application, or a combination thereof;
transmitting, via a communications network, the authorization request to a verification system to determine eligibility of the user for the program based on the input data; and
obtaining from the verification system, via the communications network, authorization data indicating whether the user is approved or denied, wherein if the user is approved the authorization data further comprises an amount of subsidy approved for the user.

10. The method of claim 9, further comprising:
generating a printed receipt comprising a unique identifier corresponding to the authorization data.

11. The method of claim 9, further comprising:
storing the authorization data in a database with a unique identifier corresponding to the user, and
generating a printed receipt comprising the unique identifier.

12. The method of claim 11, further comprising:
scanning the printed receipt with a mobile device to retrieve the authorization data;
collecting payment, via a payment device, from the user for a subsidized price corresponding to a subsidized telecommunications device and service, the subsidized price determined based on the authorization data; and
activating the subsidized telecommunications device and service, and delivering the subsidized telecommunications device and service to the user.

13. The method of claim 12, further comprising:
scanning the printed receipt with a mobile device to retrieve the unique identifier corresponding to the user;
transmitting the unique identifier from the mobile device to the database to retrieve the authorization data corresponding to the unique identifier; and
receiving, by the mobile device, the authorization data corresponding to the unique identifier from the database.

14. The method of claim 13, further comprising:
collecting payment, via a payment device, from the user for a subsidized price corresponding to a subsidized telecommunications device and service, the subsidized price determined based on the authorization data; and
activating the subsidized telecommunications device and service, and delivering the subsidized telecommunications device and service to the user.

15. The method of claim 13, further comprising:
generating an output, via the user interface, comprising options for subsidized telecommunications devices and services and corresponding subsidized prices based on the amount of subsidy approved for the user when the authorization data indicates the user is approved;
obtaining, via the user interface, a selected telecommunications device and service from the options for subsidized telecommunications devices and services;
collecting payment, via a payment device, from the user for the subsidized price corresponding to the selected telecommunications device and service;
communicating, via the communications network, with a service provider to request activation of the selected telecommunications device and service; and
delivering the selected telecommunications device and service to the user.

16. The method of claim 9, further comprising
transmitting, via a communications network, an enrollment request to the enrollment system to enroll the user into the program, the enrollment request is based on the input data.

17. A device for enrolling a user to a program for a subsidized telecommunications device and service comprising:
a user interface for displaying output and receiving input from the user, and
a transceiver configured to receive, via a communications network, data from a verification system and transmit data to the verification system; and
a processor and a non-transitory computer readable storage medium including a set of instructions executable by the processor, the set of instructions operable to:
obtain, via a user interface, an input corresponding to a status of an application for the program;
obtain, via the user interface, an identifier and retrieving, via a communications network, an existing application corresponding to the identifier from a sign-up system when the status indicates the application was previously initiated, and initiating a new application for the program when the status indicates the application for the program was not previously initiated;
obtain, via the user interface, input data from the user for completing the application for the program when a new application is initiated or when the previously initiated application for the program was not previously completed;
transmit, via a communications network, the input data to the sign-up system to generate an authorization request based on the input data, the existing application, or a combination thereof;
transmit, via a communications network, the authorization request to a verification system to determine eligibility of the user for the program based on the input data; and
obtain from the verification system, via the communications network, authorization data indicating whether the user is approved or denied, wherein if the user is approved the authorization data further comprises an amount of subsidy approved for the user.

18. The device of claim 17, wherein the set of instructions are further operable to:
generate a printed receipt comprising a unique identifier corresponding to the authorization data.

19. The device of claim 17, wherein the set of instructions are further operable to:
generate an output, via the user interface, comprising options for subsidized telecommunications devices and services and corresponding subsidized prices based on the amount of subsidy approved for the user when the authorization data indicates the user is approved;
obtain, via the user interface, a selected telecommunications device and service from the options for subsidized telecommunications devices and services;
collect payment, via a payment device, from the user for the subsidized price corresponding to the selected telecommunications device and service;
communicate, via the communications network, with a service provider to request activation of the selected telecommunications device and service; and
deliver the selected telecommunications device and service to the user.
